(19) United States
(12) Patent Application Publication
(10) Pub. No.: US 2005/0275566 A1
(43) Pub. Date: Dec. 15, 2005

(54) System and method for transferring content

(75) Inventors: Atte Lahtiranta, (US); Otto Chrons, (US)

Correspondence Address: FOLEY & LARDNER, 321 NORTH CLARK STREET, SUITE 2800, CHICAGO, IL, 60610-4764, US

(73) Assignee: Nokia Corporation

(21) Appl. No.: 10/868,672

(22) Filed: Jun. 14, 2004

(51) Int. Cl. G06F 17/30

(52) U.S. Cl. 341/22

(57) ABSTRACT

A system and method for transferring content. Embodiments of the invention may include receiving a request for a content item; downloading data identifying the content item; and downloading data representing the content item. The content item may be placed after the data identifying the content item. A portion of the data identifying the content item may be rendered at the mobile device before data representing the content item is completely downloaded at the mobile device. Also, a portion of the data representing the content item may be available for use at the mobile device before the data representing the content item is completely downloaded at the mobile device.

### FIELD OF THE INVENTION

The present invention relates to the field of content transfer and, in particular, to systems and methods for downloading content from a server to a mobile device such as a mobile or cellular telephone, for example.

### BACKGROUND

The amount of content and the number of applications available for mobile device users continues to increase rapidly. In addition to the graphics and ring tones that have been available to mobile device users for some time now, content developers are increasingly making available to mobile device users games, music, videos, applications and the like.

Depending on the nature of the content, downloading the content to a mobile device can be problematic. The size of the downloadable content files can have a direct impact on the downloading experience. For example, small downloads may not need any type of specific handling and may be started and completed synchronously while an end user waits in a progress dialog. For large files, however, downloads may be problematic for a number of reasons. For example, large files may be subject to interruption due to incoming calls on a mobile device, poor signal reception, power supply inadequacy and the like. In addition, available bandwidth may be relatively low and download speeds may be relatively slow, thereby limiting the ease with which a large file can be downloadable. Some content items may be so large in size that downloading to a mobile device is effectively impractical. In such a situation, the mobile device user, the content service provider and the content developer all suffer.

The difficulties in downloading content to a mobile device are exacerbated when textual data and binary data relating to one content item are transferred in separate files. When data is transferred in this manner, the binary data arrives at the mobile device at a later time than the textual data; thus, the textual data and the binary data cannot be viewed at the same time. Such a situation is similar to that experienced in common browsing on the Internet. For example, when browsing a web site and downloading content from that web site, binary data representing a viewable figure on a screen is not included in the HTML file during transfer but is sent as a separate file from the HTML file. Thus, the binary data cannot be viewed at the same time as the textual data in the HTML file.

### SUMMARY

According to embodiments of the present invention, a method for transferring content may include receiving a request for a content item; downloading data identifying the content item; and downloading data representing the content item. The content item is placed after the data identifying the content item. In addition, the data identifying the content item may include textual data and the data representing the content item may include binary data. The data identifying the content item and the data representing content item may be part of an XML file. The XML file may be parsable.

According to embodiments of the present invention, downloading the data identifying the content item and downloading the data representing the content item may include downloading asynchronously. Downloading the data identifying the content item and downloading the data representing the content item may include downloading to a mobile device. The mobile device may be a mobile telephone. The data identifying the content item and the data representing the content item may be downloaded from a server to the mobile device. The method may also include rendering at the mobile device a portion of the data identifying the content item before the data representing the content item is completely downloaded at the mobile device and making available for use at the mobile device a portion of the data representing the content item before the data representing the content item is completely downloaded at the mobile device.

According to an embodiment of the present invention, a system for transferring content may include a storage device for storing a content item and a processor for initiating content item downloads. The processor may be configured to receive a request for a content item; download data identifying the content item; and download data representing the content item. The processor may place data representing the content item after the data identifying the content item.

The data identifying the content item may include textual data and the data representing the content item may include binary data. The data identifying the content item and the data representing content item may be part of an XML file. The XML file may be parsable.

The storage device and the processor may be disposed in a server computer. The server computer may download to a mobile device, which may be a mobile telephone. The mobile device may be configured such that a portion of the data identifying the content item may be rendered at the mobile device before the data representing the content item is completely downloaded at the mobile device. The mobile device may also be configured such that a portion of the data representing the content item may be available for use at the mobile device before the data representing the content item is completely downloaded at the mobile device.

According to an embodiment of the present invention, a computer program product may include a computer useable medium having computer program logic recorded thereon for enabling a processor to transfer content, and the computer program logic may include a receiving procedure that enables the processor to receive a request for a content item; a first placing procedure that enables the processor to place textual data identifying the content item in a file; a second placing procedure that enables the processor to place binary data representing the content item in the file; and a downloading procedure that enables the processor to download the file. The processor may place the binary data after the textual data in the file. The file may be an XML file and may be parsable in real time.

### BRIEF DESCRIPTION OF THE DRAWINGS

A detailed description of embodiments of the invention will be made with reference to the accompanying drawings, wherein like numerals designate corresponding parts in the several figures.

FIG. 1 is a generalized block diagram of the system environment that provides the management and delivery of content according to an embodiment of the present invention.

FIG. 2 is a generalized block diagram of a system implementation for the management and delivery of content according to an embodiment of the present invention.

FIG. 3 is a generalized flow diagram for content transfer according to an embodiment of the present invention.

### DETAILED DESCRIPTION OF EXEMPLARY EMBODIMENTS

In the following description of preferred embodiments, reference is made to the accompanying drawings which form a part hereof, and in which is shown by way of illustration specific embodiments in which the invention may be practiced. It is to be understood that other embodiments may be utilized and structural changes may be made without departing from the scope of the preferred embodiments of the present invention.

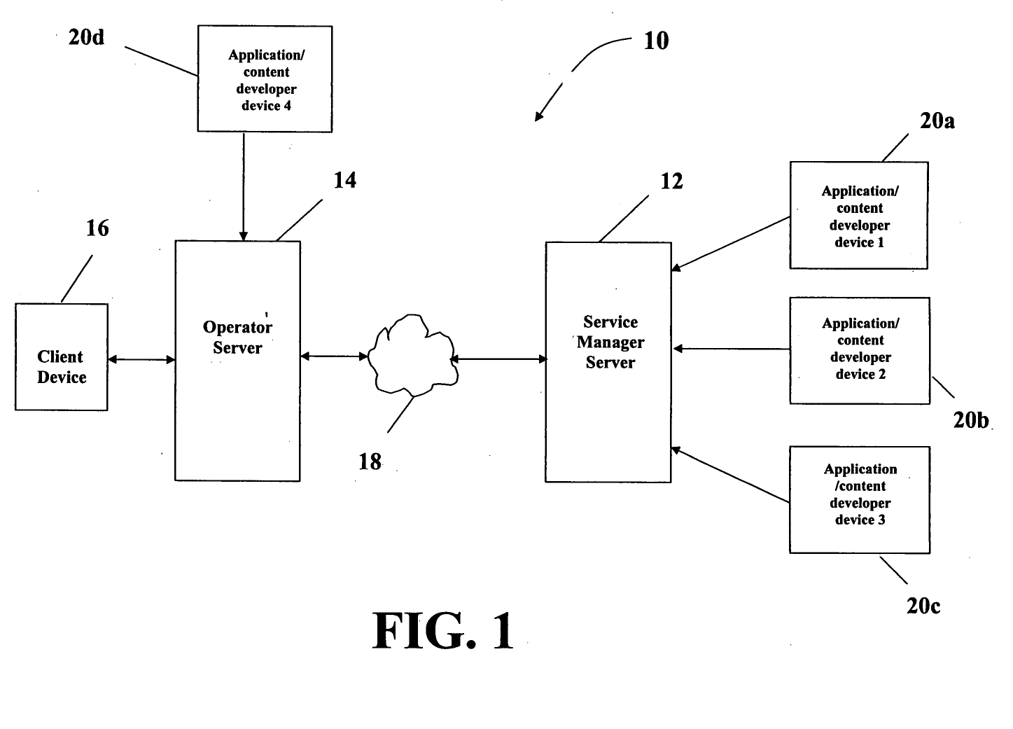

FIG. 1 is a general block diagram of a system for content transfer 10 according to an embodiment of the present invention. The system for content transfer 10 of FIG. 1 may include, without limitation, a service manager server 12, an operator server 14 and a client device 16. The service manager server 12 and the operator server 14 may be connected via a network 18. One or more application/content developer devices, 20a, 20b and 20c may interface with the service manager server 12. Likewise, one or more application/content developer devices 20d may interface with the operator server 14. The client device 16 may interface with the operator server 14. According to an embodiment of the present invention, the interface between the client device 16 and the operator server 14 may be direct or indirect and may be through a wireless connection.

The service manager server 12 may be a single server or may be multiple servers. In addition, the service manager server 12 may be configured as a server computer that is common in the art and may include, without limitation, memory, one or more processors, input, output and the like. Similarly, the operator server 14 may be configured as a server computer common in the art and may also include, without limitation, memory, one or more processors, input, output and the like. The client device may be any of a variety of mobile devices that are common in the art. For example, the client device may be a cellular telephone, a personal digital assistant and the like. The network 18 may be the internet, a wide area network, a local area network and the like.

In the embodiment of the invention shown in FIG. 1, content is made available by content developers via the application/content developer devices 20a, 20b and 20c to the service manager server 12. For purposes of the description of embodiments of the present invention herein, the term “content” will be used to apply to any type of content or application that may be stored on a server and downloaded to a client. For example, content may include MIDI files, WAV files, MP3 files, JPEG images, PNG images, applications native to the client device, Mobile Information Device Profile (MIDP) applications, and the like. Content may be developed or created by developers and delivered in any of a variety of formats to the service manager 12. For example, content may be sent via a network from a developer device 20a, 20b and 20c to the service manager server 12.

According to another embodiment of the present invention, content created by a developer may be delivered to the service manager server 12 via a fixed medium such as, for example, a CD or a DVD. The content may then be loaded onto the service manager server 12 via an appropriate hardware mechanism such as, for example, a CD drive or a DVD drive.

In FIG. 1, if the user of the client device 16 is interested in downloading content to the client device 16, the client device may send a message to the operator server 14 which may, in turn, request content from the service manager server 12. The service manager server 12 may then deliver the content via the network 18 to the operator server 14, which, in turn, can send the content to the client device 16.

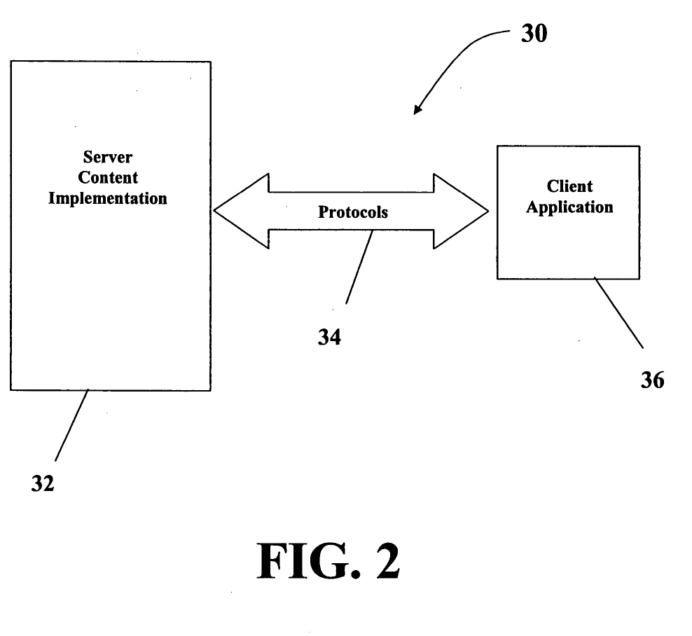

FIG. 2 shows a client-server implementation 30 for content management and delivery according to an embodiment of the present invention. In FIG. 2, content 32 may be implemented on a server while an application 36 may be implemented on a client device. The application 36 on the client device may access the content 32 implemented on the server via protocols 34 that may be sent in between a client device and a server via a network or some other mechanism.

The content 32 may be implemented on the server as one or more content catalogs that comprise content items. The application 36 may be a content purchasing client on a mobile device that allows the user to access the catalogs and the content items for preview and purchase. The client-server mechanism may be based on a variety of protocols and messaging semantics and may be based on a variety of platforms and standards such as, for example, the Open Mobile Alliance (OMA). For example, according to an embodiment of the present invention, the client-server mechanism may be based on the HTTP protocol using XML messaging semantics that describe both the client-server interactions as well as catalog descriptions.

In addition, embodiments of the present invention, may include a download descriptor scheme that supports, for example, Java MIDP Over-The-Air (OTA) and OMA Download. Downloadable objects may be described and separate download OTA mechanisms may be supported. Thus, a client may download Java MIDlets and native applications in addition to rendered content. The download descriptor may be an XML described content item that may include OTA mechanisms or may embed a Java decompiler and OMA download descriptor into an XML message structure.

Moreover, according to an embodiment of the present invention, the application 36 may be implemented such that it is OTA upgradeable and supports dynamic branding, as will be explained in greater detail below. In addition, the application 36 may include a protection mechanism such as an OMA digital rights management system to, among other things, protect purchased content and support mew business models as they become available.

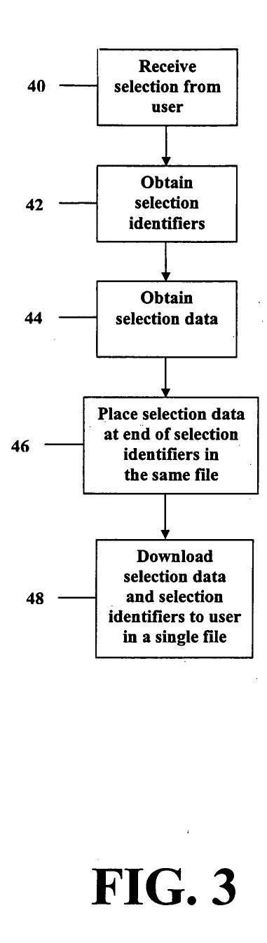

FIG. 3 shows a generalized flow diagram for content transfer according to an embodiment of the present invention. The flow diagram of FIG. 3 may be used in a variety of applications and environments. For example, according to an embodiment of the present invention, the flow diagram of FIG. 3 may be implemented in a client-server application where the client is a mobile device such as a mobile telephone, for example. In addition, the flow diagram of FIG. 3 may be implemented in the system shown in FIG. 1, for example. Also, the flow diagram of FIG. 3 may be implemented in a computer program product that includes a computer useable medium having computer program logic recorded thereon for enabling a processor to perform the steps shown in the flow diagram of FIG. 3.

At step 40, a content item selection originating with a mobile device user is received at the server. The content item selection may be for any type of content item, such as, for example, a graphics file, ring-tones, music, animated video, feature films and the like. The content item may be selected from a database existing on the server that has been presented to the mobile device user on the mobile device. The database may be organized in a hierarchical fashion, which may include, for example, catalogs, sub-catalogs, categories and the like.

At step 42, the server obtains identifying information relating to the selection from its database. The identifying information may include textual information or textual data. The identifying information may be embedded in an XML message and may include, for example, the name of the content item, a brief description of the content item, the price of the content item, payment information, the size of the content item and the like. For example, if the content item is a game, the identifying information may include the name of the game, a description of the game, the cost for downloading the game, the size of the downloadable file and the like.

Once the server has obtained identifying information relating to the selection, at step 44 the server obtains the actual data representing the selection. The actual data representing the selection may be binary data. For example, if the content item selected is a game, the server may obtain the actual binary data representing the game. If the game, for example, is relatively complex and includes, for example, detailed graphics, CD quality sound and the like, the amount of actual data representing the game may be extensive.

At step 46, the actual data representing the selection is embedded in its own block in the same XML message in which the identifying information is embedded and placed at the end of the XML message. In other words, the textual data and the binary data for a single content item are placed in the same file, with the textual data at the beginning of the file and the binary data in its own block at the end of the file.

The delivery of a requested content item selection may require the delivery of one or more messages to the client device. For example, delivery of a particular content item may require delivery of a plurality of XML messages. At step 50, the one or more messages containing the identifying information of the selection and the actual data representing the selection may be downloaded to the client device. In other words, one or more files, each containing textual data in the beginning of the file and binary data at the end of the file, may be downloaded to the client device.

For example, if a user makes a request to download a content item such as a game, the content downloading client may show various information relating to the game on the client device display, such as, for example, the name of the game, an abstract of the game, the price of the game and the like, all of which is textual data. In addition, the same file that includes the textual data also includes binary data in its own block at the end of the file. The binary data may represent a logo or some screenshots, for example. Thus, because the textual data and the binary data are included in the same file, the client device may display the logos and screenshots represented by the binary data and the information represented by the textual data at the same time.

Because the downloaded selection may include a plurality of messages in which are embedded information identifying the selection and actual selection data, the messages may be downloaded asynchronously. Thus, portions of the selection content may be usable at the client device before the entire selection has been completely downloaded. In addition, according to embodiments of the present invention, the downloaded messages may be parsable at the client device. Thus, because the messages have been prioritized with textual data in the beginning of the message and binary data at the end of the message, selected content items may be rendered in real time at the client device before all content items have been completely downloaded.

Also, processing of the messages may be interrupted if the end user chooses to do so. However, because the messages may be downloaded asynchronously and because the messages are parsable and because the messages have been prioritized with textual data in the beginning of the message and binary data at the end of the message, the end user may choose to do other tasks and selection download can be scheduled at another time without loss of data.

While particular embodiments of the present invention have been shown and described, it will be obvious to those skilled in the art that the invention is not limited to the particular embodiments shown and described and that changes and modifications may be made without departing from the spirit and scope of the appended claims.

1. A method for transferring content comprising:
receiving a request for a content item;
placing textual data identifying the content item in a file;
placing binary data representing the content item in the file; and
downloading the file,
wherein the binary data is placed after the textual data in the file.

2. The method of claim 1, wherein the file is an XML file.

3. The method of claim 2, wherein the XML file is parsable in real time.

4. The method of claim 1, wherein downloading comprises downloading to a mobile device.

5. The method of claim 4, wherein the mobile device is a mobile telephone.

6. The method of claim 4, wherein downloading comprises downloading from a server to the mobile device.

7. The method of claim 4, further comprising rendering at the mobile device a portion of the textual data before the binary data is completely downloaded at the mobile device.

8. The method of claim 4, further comprising making available for use at the mobile device a portion of the binary data before the binary data is completely downloaded at the mobile device.

9. A system for transferring content comprising:
a storage device for storing a content item; and
a processor communicatively coupled to the storage device for initiating content item downloads,
wherein the processor is configured to:
receive a request for a content item;
place textual data identifying the content item in a file;
place binary data representing the content item in the file; and
download the file,
wherein the processor places the binary data after the textual data in the file.

10. The system of claim 9, wherein the file is an XML file.

11. The system of claim 10, wherein the XML file is parsable in real time.

12. The system of claim 9, wherein the storage device and the processor are disposed in a server computer.

13. The system of claim 12, wherein the server computer downloads to a mobile device.

14. The system of claim 13, wherein the mobile device is a mobile telephone.

15. The system of claim 13, wherein the mobile device is configured such that a portion of the textual data is rendered at the mobile device before the binary data is completely downloaded at the mobile device.

16. The system of claim 13, wherein the mobile device is configured such that a portion of the binary data is available for use at the mobile device before the binary data is completely downloaded at the mobile device.

17. A system for transferring content comprising:
means for receiving a request for a content item;
means for placing textual data identifying the content item in a file; and
means for placing binary data representing the content item in the file; and
means for downloading the file,
wherein the binary data is placed after the textual data in the file.

18. A computer program product comprising a computer useable medium having computer program logic recorded thereon for enabling a processor to transfer content, the computer program logic comprising:
a receiving procedure that enables the processor to receive a request for a content item;
a first placing procedure that enables the processor to place textual data identifying the content item in a file;
a second placing procedure that enables the processor to place binary data representing the content item in the file; and
a downloading procedure that enables the processor to download the file,
wherein the processor places the binary data after the textual data in the file.

19. The computer program product of claim 18, wherein the file is an XML file.

20. The computer program product of claim 19, wherein the XML file is parsable in real time.

21. A device for transferring content comprising:
a storage unit for storing a content item; and
a processor communicatively coupled to the storage unit for initiating content item downloads,
wherein the processor is configured to:
receive a request for a content item;
place textual data identifying the content item in a file;
place binary data representing the content item in the file; and
download the file,
wherein the processor places the binary data after the textual data in the file.

22. The device of claim 21, wherein the file is an XML file.

23. The device of claim 22, wherein the XML file is parsable in real time.

24. The device of claim 21, wherein the storage unit and the processor are disposed in a server computer.

25. The device of claim 12, wherein the server computer downloads to a mobile device.

26. The device of claim 13, wherein the mobile device is a mobile telephone.

27. The device of claim 9, wherein the mobile device is configured such that a portion of the textual data is rendered at the mobile device before the binary data is completely downloaded at the mobile device.

28. The device of claim 12, wherein the mobile device is configured such that a portion of the binary data is available for use at the mobile device before the binary data is completely downloaded at the mobile device.
